(19) United States
(12) Patent Application Publication
(10) Pub. No.: US 2025/0184932 A1
(43) Pub. Date: Jun. 5, 2025

(54) SPECTRUM SHARING BETWEEN DIFFERENT CELLULAR TECHNOLOGIES

(71) Applicant: QUALCOMM Incorporated, San Diego, CA (US)

(72) Inventors: Kazuki TAKEDA, Minato-ku (JP); Jing LEI, San Diego, CA (US); Kianoush HOSSEINI, San Diego, CA (US)

(21) Appl. No.: 18/527,161

(22) Filed: Dec. 1, 2023

(51) Int. Cl. H04W 56/00; H04W 72/30; H04W 72/51

(52) U.S. Cl. CPC H04W 56/0015; H04W 72/30; H04W 72/51

(57) ABSTRACT

Methods, systems, and devices for wireless communications are described. A user equipment (UE) may receive, via a set of synchronization channel resources, a synchronization message from a network entity, wherein the set of synchronization channel resources and a first subset of broadcast channel resources are both associated with a first cellular technology. The UE may receive, via a second subset of broadcast channel resources and according to the synchronization message, a broadcast message from the network entity, the second subset of broadcast channel resources associated with a second cellular technology that is different from the first cellular technology. The UE may communicate with the network entity using the first cellular technology, the second cellular technology, or both, in accordance with the synchronization message and the broadcast message.

### FIELD OF TECHNOLOGY

The present disclosure relates to wireless communications, including spectrum sharing between different cellular technologies.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support spectrum sharing between different cellular technologies. For example, the described techniques provide for reuse schemes that may support coexistence between fifth generation (5G) and sixth generation (6G) wireless networks when frequency resources are shared between the networks. The reuse schemes may be applied for synchronization signal broadcast (SSB) or other reference signal(s) that, to some degree, may be reused by both 5G and 6G wireless devices. This may include a user equipment (UE) receiving a synchronization message (e.g., a primary synchronization signal (PSS) message, a secondary synchronization signal (SSS) message, or both) via a set of synchronization signal resources. The PSS/SSS resources may generally be associated with a first cellular technology (e.g., 5G). The 5G PSS/SSS resources may be associated with a first subset of broadcast channel resources (e.g., physical broadcast channel (PBCH) resources) that are also associated with the first cellular technology (e.g., 5G PBCH resources). The UE may receive a broadcast message (e.g., a PBCH message) that is associated with a second cellular technology (e.g., 6G). The broadcast message may be associated with a second subset of broadcast channel resources (e.g., 6G PBCH resources). The UE may communicate with the network using the 5G, the 6G, or both, cellular technologies in accordance with the synchronization message (e.g., 5G PSS/SSS) and the broadcast message (e.g., 6G PBCH). Accordingly, the described techniques may be used to share SSB resources (or other reference signal resources) between coexisting wireless networks.

A method for wireless communications by a UE is described. The method may include receiving, via a set of synchronization channel resources, a synchronization message from a network entity, where the set of synchronization channel resources and a first subset of broadcast channel resources are both associated with a first cellular technology, receiving, via a second subset of broadcast channel resources and according to the synchronization message, a broadcast message from the network entity, the second subset of broadcast channel resources associated with a second cellular technology that is different from the first cellular technology, and communicating with the network entity using the first cellular technology, the second cellular technology, or both, in accordance with the synchronization message and the broadcast message.

A UE for wireless communications is described. The UE may include one or more memories storing processor executable code, and one or more processors coupled with the one or more memories. The one or more processors may individually or collectively operable to execute the code to cause the UE to receive, via a set of synchronization channel resources, a synchronization message from a network entity, where the set of synchronization channel resources and a first subset of broadcast channel resources are both associated with a first cellular technology, receive, via a second subset of broadcast channel resources and according to the synchronization message, a broadcast message from the network entity, the second subset of broadcast channel resources associated with a second cellular technology that is different from the first cellular technology, and communicate with the network entity using the first cellular technology, the second cellular technology, or both, in accordance with the synchronization message and the broadcast message.

Another UE for wireless communications is described. The UE may include means for receiving, via a set of synchronization channel resources, a synchronization message from a network entity, where the set of synchronization channel resources and a first subset of broadcast channel resources are both associated with a first cellular technology, means for receiving, via a second subset of broadcast channel resources and according to the synchronization message, a broadcast message from the network entity, the second subset of broadcast channel resources associated with a second cellular technology that is different from the first cellular technology, and means for communicating with the network entity using the first cellular technology, the second cellular technology, or both, in accordance with the synchronization message and the broadcast message.

A non-transitory computer-readable medium storing code for wireless communications is described. The code may include instructions executable by one or more processors to receive, via a set of synchronization channel resources, a synchronization message from a network entity, where the set of synchronization channel resources and a first subset of broadcast channel resources are both associated with a first cellular technology, receive, via a second subset of broadcast channel resources and according to the synchronization message, a broadcast message from the network entity, the second subset of broadcast channel resources associated with a second cellular technology that is different from the first cellular technology, and communicate with the network entity using the first cellular technology, the second cellular technology, or both, in accordance with the synchronization message and the broadcast message.

Some examples of the method, user equipment (UEs), and non-transitory computer-readable medium described herein may further include operations, features, means, or instructions for receiving, via the first subset of broadcast channel resources, a demodulation reference signal associated with the first cellular technology, where receiving the broadcast message using the second cellular technology may be in accordance with the demodulation reference signal.

In some examples of the method, user equipment (UEs), and non-transitory computer-readable medium described herein, receiving the synchronization message may include operations, features, means, or instructions for receiving a first portion of a synchronization signal block (SSB) index in accordance with the demodulation reference signal and receiving a second portion of the SSB index in accordance with the broadcast message.

Some examples of the method, user equipment (UEs), and non-transitory computer-readable medium described herein may further include operations, features, means, or instructions for transmitting a capability message indicating UE support for using a demodulation reference signal associated with the first cellular technology to receive the broadcast message, where receiving the broadcast message may be in accordance with the capability message.

In some examples of the method, user equipment (UEs), and non-transitory computer-readable medium described herein, a location of the first subset of broadcast channel resources, the second subset of broadcast channel resources, or both, may be within a carrier bandwidth associated with the UE.

In some examples of the method, user equipment (UEs), and non-transitory computer-readable medium described herein, a relative position in a frequency domain for the first subset of broadcast channel resources and the second subset of broadcast channel resources may be defined with respect to the location.

Some examples of the method, user equipment (UEs), and non-transitory computer-readable medium described herein may further include operations, features, means, or instructions for performing one or more blind decoding attempts of the broadcast message using a set of relative position hypotheses in a frequency domain for the first subset of broadcast channel resources and the second subset of broadcast channel resources.

In some examples of the method, user equipment (UEs), and non-transitory computer-readable medium described herein, a synchronization signal block (SSB) index associated with the first subset of broadcast channel resources and the second subset of broadcast channel resources may be identified based on a successful blind decoding attempt.

Some examples of the method, user equipment (UEs), and non-transitory computer-readable medium described herein may further include operations, features, means, or instructions for receiving information identifying a relative position hypothesis in a frequency domain for the first subset of broadcast channel resources and the second subset of broadcast channel resources and decoding the broadcast message in accordance with the relative position hypothesis.

In some examples of the method, user equipment (UEs), and non-transitory computer-readable medium described herein, the information includes a first mapping between an identifier associated with the synchronization message and the relative position hypothesis, a second mapping between a synchronization raster associated with the set of synchronization channel resources and the relative position hypothesis, a third mapping between a frequency band associated with the set of synchronization channel resources and the relative position hypothesis, or a combination thereof.

In some examples of the method, user equipment (UEs), and non-transitory computer-readable medium described herein, the first subset of broadcast channel resources and the second subset of broadcast channel resources include overlapping time resources or non-overlapping time resources.

In some examples of the method, user equipment (UEs), and non-transitory computer-readable medium described herein, the broadcast message indicates time and frequency resources for the communicating with the network entity in accordance with the first cellular technology, the second cellular technology, or both.

A method for wireless communications by a network entity is described. The method may include outputting, via a set of synchronization channel resources, a synchronization message to a UE, where the set of synchronization channel resources and a first subset of broadcast channel resources are both associated with a first cellular technology, outputting, via a second subset of broadcast channel resources and according to the synchronization message, a broadcast message from the network entity, the second subset of broadcast channel resources associated with a second cellular technology that is different from the first cellular technology, and communicating with the UE using the first cellular technology, the second cellular technology, or both, in accordance with the synchronization message and the broadcast message.

A network entity for wireless communications is described. The network entity may include one or more memories storing processor executable code, and one or more processors coupled with the one or more memories. The one or more processors may individually or collectively operable to execute the code to cause the network entity to output, via a set of synchronization channel resources, a synchronization message to a UE, where the set of synchronization channel resources and a first subset of broadcast channel resources are both associated with a first cellular technology, output, via a second subset of broadcast channel resources and according to the synchronization message, a broadcast message from the network entity, the second subset of broadcast channel resources associated with a second cellular technology that is different from the first cellular technology, and communicate with the UE using the first cellular technology, the second cellular technology, or both, in accordance with the synchronization message and the broadcast message.

Another network entity for wireless communications is described. The network entity may include means for outputting, via a set of synchronization channel resources, a synchronization message to a UE, where the set of synchronization channel resources and a first subset of broadcast channel resources are both associated with a first cellular technology, means for outputting, via a second subset of broadcast channel resources and according to the synchronization message, a broadcast message from the network entity, the second subset of broadcast channel resources associated with a second cellular technology that is different from the first cellular technology, and means for communicating with the UE using the first cellular technology, the second cellular technology, or both, in accordance with the synchronization message and the broadcast message.

A non-transitory computer-readable medium storing code for wireless communications is described. The code may include instructions executable by one or more processors to output, via a set of synchronization channel resources, a synchronization message to a UE, where the set of synchronization channel resources and a first subset of broadcast channel resources are both associated with a first cellular technology, output, via a second subset of broadcast channel resources and according to the synchronization message, a broadcast message from the network entity, the second subset of broadcast channel resources associated with a second cellular technology that is different from the first cellular technology, and communicate with the UE using the first cellular technology, the second cellular technology, or both, in accordance with the synchronization message and the broadcast message.

Some examples of the method, network entities, and non-transitory computer-readable medium described herein may further include operations, features, means, or instructions for outputting, via the first subset of broadcast channel resources, a demodulation reference signal associated with the first cellular technology, where outputting the broadcast message using the second cellular technology may be in accordance with the demodulation reference signal.

In some examples of the method, network entities, and non-transitory computer-readable medium described herein, a first portion of a synchronization signal block (SSB) index may be identified in accordance with the demodulation reference signal and a second portion of the SSB index may be identified in accordance with the broadcast message.

Some examples of the method, network entities, and non-transitory computer-readable medium described herein may further include operations, features, means, or instructions for obtaining a capability message indicating UE support for using a demodulation reference signal associated with the first cellular technology to receive the broadcast message, where outputting the broadcast message may be in accordance with the capability message.

In some examples of the method, network entities, and non-transitory computer-readable medium described herein, a location of the first subset of broadcast channel resources, the second subset of broadcast channel resources, or both, may be within a carrier bandwidth associated with the UE.

In some examples of the method, network entities, and non-transitory computer-readable medium described herein, a relative position in a frequency domain for the first subset of broadcast channel resources and the second subset of broadcast channel resources may be defined with respect to the location.

Some examples of the method, network entities, and non-transitory computer-readable medium described herein may further include operations, features, means, or instructions for outputting information to the UE identifying a relative position hypothesis in a frequency domain for the first subset of broadcast channel resources and the second subset of broadcast channel resources, where the UE decodes the broadcast message in accordance with the relative position hypothesis.

In some examples of the method, network entities, and non-transitory computer-readable medium described herein, the information includes a first mapping between an identifier associated with the synchronization message and the relative position hypothesis, a second mapping between a synchronization raster associated with the set of synchronization channel resources and the relative position hypothesis, a third mapping between a frequency band associated with the set of synchronization channel resources and the relative position hypothesis, or a combination thereof.

In some examples of the method, network entities, and non-transitory computer-readable medium described herein, the first subset of broadcast channel resources and the second subset of broadcast channel resources include overlapping time resources or non-overlapping time resources.

In some examples of the method, network entities, and non-transitory computer-readable medium described herein, the broadcast message indicates time and frequency resources for the communicating with the network entity in accordance with the first cellular technology, the second cellular technology, or both.

### BRIEF DESCRIPTION OF THE DRAWINGS

FIG. 1 shows an example of a wireless communications system that supports spectrum sharing between different cellular technologies in accordance with one or more aspects of the present disclosure.

FIG. 2 shows an example of a wireless communications system that supports spectrum sharing between different cellular technologies in accordance with one or more aspects of the present disclosure.

FIGS. 3A-3C show examples of a spectrum sharing scheme that supports spectrum sharing between different cellular technologies in accordance with one or more aspects of the present disclosure.

FIG. 4 shows an example of a spectrum sharing scheme that supports spectrum sharing between different cellular technologies in accordance with one or more aspects of the present disclosure.

FIGS. 5 and 6 show block diagrams of devices that support spectrum sharing between different cellular technologies in accordance with one or more aspects of the present disclosure.

FIG. 7 shows a block diagram of a communications manager that supports spectrum sharing between different cellular technologies in accordance with one or more aspects of the present disclosure.

FIG. 8 shows a diagram of a system including a device that supports spectrum sharing between different cellular technologies in accordance with one or more aspects of the present disclosure.

FIGS. 9 and 10 show block diagrams of devices that support spectrum sharing between different cellular technologies in accordance with one or more aspects of the present disclosure.

FIG. 11 shows a block diagram of a communications manager that supports spectrum sharing between different cellular technologies in accordance with one or more aspects of the present disclosure.

FIG. 12 shows a diagram of a system including a device that supports spectrum sharing between different cellular technologies in accordance with one or more aspects of the present disclosure.

FIGS. 13 through 17 show flowcharts illustrating methods that support spectrum sharing between different cellular technologies in accordance with one or more aspects of the present disclosure.

### DETAILED DESCRIPTION

Cellular technology for wireless communications evolves over time. This evolution may lead to coexistence issues when different networks deploy different cellular technologies (such as different generations of a standardized radio access technology) in overlapping coverage areas serving the same or different user equipment (UE). For example, 3GPP fifth generation (5G) and sixth generation (6G) networks may share various resources, such as time, frequency, and spatial resources, but use different waveform designs. Deploying such overlapping and coexisting networks may lead to inefficient resource use, such as each cellular technology separately configuring various parameters for UE using the shared resources. In such cases, it may be desirable to implement a mechanism for both cellular technologies to coexist in a more efficient manner that conserves available resources.

Accordingly, the described techniques provide for reuse schemes that may support coexistence between different cellular technologies, such as 5G and 6G, of wireless networks when frequency resources are shared between networks. The reuse schemes may be applied for synchronization signal broadcast (SSB) or other reference signal(s) that, to some degree, may be reused, for example, by both cellular technologies. For example, a UE may receive a synchronization message (e.g., a primary synchronization signal (PSS) message, a secondary synchronization signal (SSS) message, or both) via a set of synchronization signal resources. The PSS/SSS resources may generally be associated with a first cellular technology (e.g., the 5G cellular technology). The 5G PSS/SSS resources may be associated with a first subset of broadcast channel resources (e.g., physical broadcast channel (PBCH) resources) that are also associated with the first cellular technology (e.g., 5G PBCH resources). The UE may receive a broadcast message (e.g., a PBCH message) that is associated with a second cellular technology (e.g., the 6G cellular technology). The broadcast message may be associated with a second subset of broadcast channel resources (e.g., 6G PBCH resources). The UE may communicate with the network using the 5G, the 6G, or both, cellular technologies in accordance with the synchronization message (e.g., 5G PSS/SSS) and the broadcast message (e.g., 6G PBCH). Accordingly, the described techniques may be used to share SSB resources (or other reference signal resources) between coexisting wireless networks.

Aspects of the disclosure are initially described in the context of wireless communications systems. Aspects of the disclosure are further illustrated by and described with reference to apparatus diagrams, system diagrams, and flowcharts that relate to spectrum sharing between different cellular technologies.

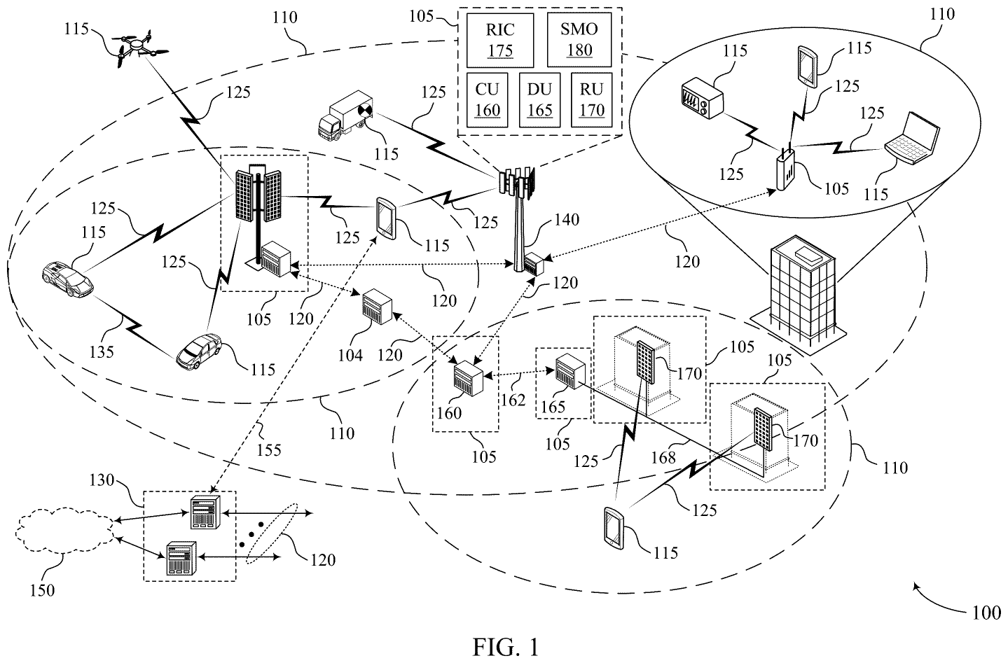

FIG. 1 shows an example of a wireless communications system 100 that supports spectrum sharing between different cellular technologies in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support 5G-6G spectrum sharing as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive, via a set of synchronization channel resources, a synchronization message from a network entity 105, wherein the set of synchronization channel resources and a first subset of broadcast channel resources are both associated with a first cellular technology, such as 5G. The UE 115 may receive, via a second subset of broadcast channel resources and according to the synchronization message, a broadcast message from the network entity 105, the second subset of broadcast channel resources associated with a second cellular technology, such as 6G, that is different from the first cellular technology. The UE 115 may communicate with the network entity 105 using the first cellular technology, the second cellular technology, or both, in accordance with the synchronization message and the broadcast message.

A network entity 105 may output, via a set of synchronization channel resources, a synchronization message to a UE 115, wherein the set of synchronization channel resources and a first subset of broadcast channel resources are both associated with a first cellular technology. The network entity 105 may output, via a second subset of broadcast channel resources and according to the synchronization message, a broadcast message from the network entity 105 (e.g., to the UE 115), the second subset of broadcast channel resources associated with a second cellular technology that is different from the first cellular technology. The network entity 105 may communicate with the UE 115 using the first cellular technology, the second cellular technology, or both, in accordance with the synchronization message and the broadcast message.

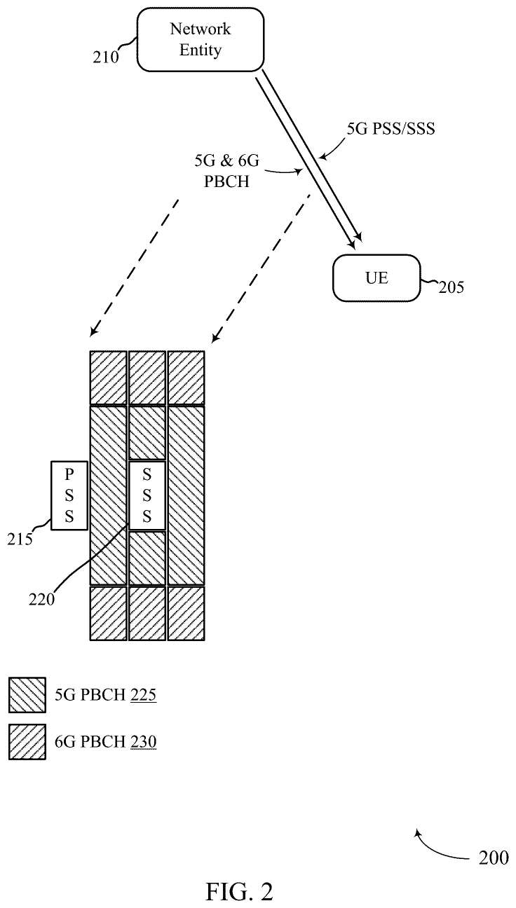

FIG. 2 shows an example of a wireless communications system 200 that supports spectrum sharing between different cellular technologies in accordance with one or more aspects of the present disclosure. Wireless communications system 200 may implement aspects of wireless communications system 100. Wireless communications system 200 may include a UE 205 and a network entity 210, which may be examples of the corresponding devices described herein.

Some wireless networks may share a portion of the frequency spectrum (e.g., frequency resources) between evolving cellular technologies. For example, LTE wireless networks previously shared frequency resources with 5G networks. However, this resources sharing is typically limited to FDD-based frequency bands having a subcarrier spacing (SCS) of 15 kHz, such as in the frequency range 1 (FR1) band. Advanced wireless networks, such as 6G cellular networks may share the spectrum with 5G cellular networks in the FDD frequency bands as well as in the TDD frequency bands and in other frequency bands (e.g., FR2).

However, coexistence between cellular technologies often results in an inefficient use of the shared resources. Different cellular technologies may use different waveform designs, have different signal/channel configurations for reference signals (e.g., SSB, system information signals, tracking reference signals (TRSs), and other distinguishing characteristics that limit which devices that may use a given technology. For example, some devices may support communications using one technology (e.g., waveform design, multiplexing scheme, and other differences), but not necessarily the other technology. This may result in each cellular network separately configuring the devices (e.g., UE) operating within their coverage area for control channel, system information block one (SIB1), SSB, reference signal, and other signaling type monitoring. Such separate configurations for the wireless devices for each cellular technology may consume extensive physical resources associated with the per-UE configuration signaling.

Moreover, cellular networks operating in some frequency bands may use directional communications where beamformed signals are used for the SSB, reference signal, and other wireless signal transmissions. Such separate configuration signaling in these networks may further increase the amount of resources used to configure each UE with using multiple beamformed transmissions.

Accordingly, aspects of the techniques described herein provide for spectrum sharing between cellular technologies in which some signals and channels are described to reduce the amount of overhead, such as the separate overhead signaling used to configure SSB, SIB1, and other signals to wireless devices (such as the UE 205). For example, 5G signal and channel sharing on a carrier may be reused by a 6G UE (e.g., the UE 205) operating on the carrier (e.g., in the shared spectrum). Some aspects may include OFDM-based waveform with the same SCS (e.g., as is used for 5G cellular technology) being used by both 5G and 6G wireless devices, such as the 6G and 5G UE sharing the same orthogonal time and frequency resource grid on the carrier. For directional networks, the network entity (or RU) may have a common set of transmit beams (e.g., beam space) for both 5G and 6G UE operating on the carrier.

Aspects of the techniques described herein may be applicable to a NR reference signal/synchronization signal (RS/SS) resources being reusable for 5G UE and 6G UE that share or operate on at least a portion of the same spectrum. Examples of the NR RS/SS resources may include, but are not limited to, SSB resources (e.g., PSS/SSS resources and PBCH resources), SIB1 resources, TRS resources, CSI-RS resources, and other always-on or otherwise known reference signals. Although the techniques discussed herein are described with reference to SSB reuse schemes for 5G and 6G UE, it is to be understood that aspects of these techniques may be applicable to any NR RS/SS or similar signaling type.

The network entity 210 may configure, define, or otherwise establish the same (e.g., a common or shared) cell, transmit beams, or both, for 5G and 6G UE operating within its coverage area. The shared cell may generally define that the 5G and 6G UE are configured or otherwise support monitoring defined frequency resources, time resources, spatial resources, or other resources to receive a transmission from the network entity 210 (e.g., such as SSB resources for SSB transmission(s)). The SSB transmission may include synchronization signals, such as PSS/SSS transmissions, and, in some examples, together with PBCH transmissions in corresponding PBCH resources.

The network entity 210 may transmit, provide, or otherwise output (and the UE 205 may receive or otherwise obtain) a synchronization message via a set of synchronization channel resources. The synchronization message may be a PSS message 215, a SSS message 220, or both the PSS message 215 and the SSS message 220. The PSS/SSS signaling may be received in synchronization channel resources, such as frequency/time/spatial resources allocated to or otherwise configured for the PSS message 215 and the SSS message 220. The synchronization channel resources may be associated with a first cellular technology, which is the 5G cellular technology (e.g., NR PSS/SSS) in this example.

The UE 205 (e.g., either a 5G UE or a 6G UE) may use the NR PSS/SSS for time and frequency tracking, initial cell/beam acquisition, radio link management (RLM)/beam failure recovery (BFR), radio resource management (RRM)/inter-cell beam measurement, beam measurement, power control for uplink (such as a PRACH transmission), and other functions. The synchronization channel resources used for the NR PSS/SSS signaling may be RRC configured or otherwise signaled to the UE 205 during a previous active connection with the network entity 210.

A first subset of broadcast channel resources may also be associated with first cellular technology. The first subset of broadcast channel resources may include 5G PBCH 225 resources, in this example. The first subset of broadcast channel resources may be RRC configured or otherwise signaled to the UE 205 during a previous active connection with the network entity 210. The 5G PBCH 225 resources may carry the PBCH payload to be read by the 5G UE. The PBCH payload may include 5G PBCH data, which may be used to master information block (MIB) data. The PBCH DMRS may be used as a reference signal for decoding the 5G PBCH data as well as indicating a portion of the index of the SSB (e.g., bits of the SSB index).

That is, the NR PBCH DMRS sequence may depend on the SSB index. There may be four or eight hypothesis that the UE uses to identify the DMRS sequence, which is associated with the SSB index. The UE finding the successful hypothesis regarding the DMRS sequence used for this 5G PBCH DMRS may carry or otherwise provide the information used to determine or acquire two or three bits of the SSB index. The remaining portion of the SSB index may be carried in the PBCH data payload (e.g., in the MIB). The 6G UE may not decode the PBCH payload carried in the 5G PBCH 225 resources.

The network entity 210 may transmit, provide or otherwise output (and the UE 205 may receive or otherwise obtain) a broadcast message via a second subset of broadcast channel resources. The second subset of broadcast channel resources may include 6G PBCH 230 resources in this example. That is, the second subset of broadcast channel resources may be associated with a second cellular technology (e.g., the 6G cellular technology) that is different from the first cellular technology (e.g., the 5G cellular technology).

The UE 205 (e.g., the 6G UE) may decode the broadcast message received via the 6G PBCH 230 resources, which carries the 6G PBCH payload and 6G PBCH DMRS signaling. In some examples, the 6G PBCH payload may carry or convey MIB information, such as a portion of the SSB index and other information used by the UE 205 to access or otherwise synchronize with the network entity 210. The broadcast message may carry or otherwise convey time/frequency resource information for the communications with the network entity 210 using the 5G cellular technology, the 6G cellular technology, or both cellular technologies. For example, the broadcast message may carry or convey time/frequency domain resources for 6G downlink channels delivering 6G system information, time/frequency/spatial domain resources for 5G uplink/downlink channels or signals, or both.

The 6G PBCH DMRS may again function as a reference signal for decoding the 6G PBCH payload as well as indicating a portion of the SSB index.

In some examples, the 6G UE (e.g., the UE 205) may be configured to or otherwise support using the 5G PBCH DMRS to identify or otherwise determine at least a portion of the SSB index. For example, the UE 205 may receive or otherwise obtain a DMRS associated with the 5G cellular technology in the first subset of broadcast channel resources (e.g., in the 5G PBCH 225 resources). The UE 205 may, therefore, receive the first portion of the SSB index (e.g., the two or three least significant bits (LSBs) of the SSB index) based on the 5G PBCH DMRS and receive the second portion of the SSB index in the broadcast message (e.g., in the 6G PBCH resources).

This scheme may enable the 6G UEs to use the 5G PBCH DMRS to identify the first portion of the SSB index that it has detected (e.g., the SSB index associated with the NR PSS/SSS). When the 6G UE supports decoding the 5G PBCH DMRS to identify the first portion of the SSB index, this may provide for the 6G PBCH payload or the 6G PBCH DMRS to not need to carry that SSB index information, which may further conserve resources. Furthermore, such 6G UE supporting using 5G PBCH DMRS signaling may provide further reference signals usable by the UE to estimate the channel to support 6G PBCH payload decoding. That is, the 6G UE may be able to use both 5G PBCH DMRS in the first subset of broadcast channel resources and the 6G PBCH DMRS in the second subset of broadcast channel resources to measure the channel conditions to improve 6G PBCH message decoding. This may improve measurement accuracy of the channel conditions by providing additional measurement opportunities. For this, the network may transmit 5G PBCH DMRS and 6G PBCH and 6G PBCH DMRS using the same precoder/transmit beam, so that the channel of 6G PBCH can be inferred from the channel over which 5G PBCH DMRS and 6G PBCH DMRS is conveyed.

The UE 205 may signal its support for use of the 5G PBCH DMRS for SSB measurements to the network entity 210. For example, the UE 205 may transmit, provide or otherwise output (and the network entity 210 may receive or otherwise obtain) a capability message indicating whether the UE 205 supports using the DMRS of the first cellular technology (e.g., the 5G PBCH DMRS carried in the 5G PBCH 225 resources) to support receiving the broadcast message (e.g., for SSB index identification and/or improved channel measurement opportunities).

Accordingly, the UE 205 may communicate with the network entity 210 using the first cellular technology (e.g., the 5G technology when the UE supports both 5G and 6G technology), the second cellular technology (e.g., the 6G UE), or both, in accordance with the synchronization message (e.g., NR or 5G PSS/SSS) and the broadcast message (e.g., 6G PBCH and, in some cases, 5G PBCH). The communications may include the UE 205 synchronizing with the network entity 210 in the time or frequency domain, channel access (e.g., PRACH), and other communications or functions.

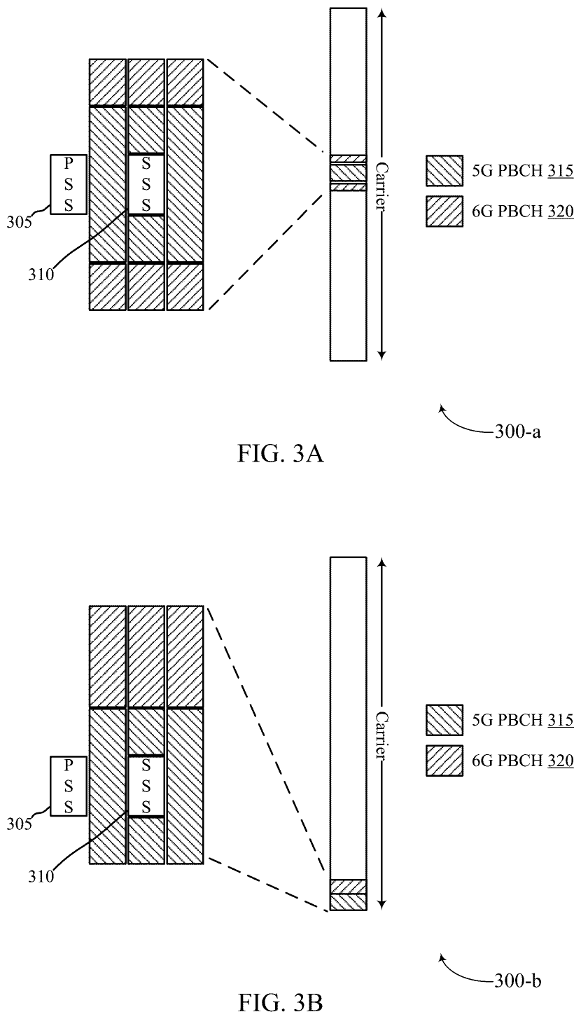

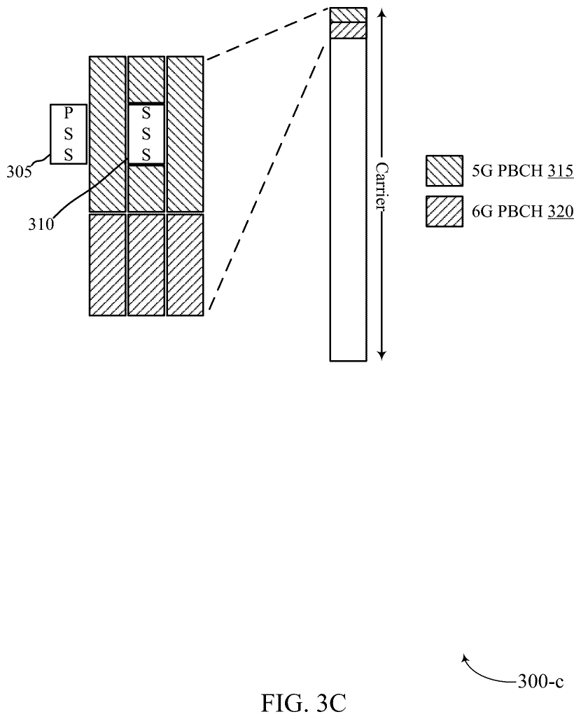

FIGS. 3A-3C show examples of a spectrum sharing scheme 300 that supports spectrum sharing between different cellular technologies in accordance with one or more aspects of the present disclosure. Spectrum sharing scheme 300 may implement aspects of wireless communications system 100 or aspects of wireless communications system 200. Aspects of spectrum sharing scheme 300 may be implemented at or implemented by a UE or a network entity, which may be examples of the corresponding devices described herein. Spectrum sharing scheme 300-a of FIG. 3A, spectrum sharing scheme 300-b of FIG. 3B, and spectrum sharing scheme 300-c of FIG. 3C show non-limiting examples of where the relative position of the shared SSB frequency resources may be located or arranged with a carrier.

The techniques described herein generally provide for extension of the SSB resources to support both 5G (e.g., a first cellular technology) and 6G (e.g., a second cellular technology) UE. That is, the UE may receive a synchronization message from a network entity via synchronization channel resources. The synchronization message may include one or both of a PSS 305 or a SSS 310. The synchronization message may be a PSS/SSS signal in accordance with the first cellular technology (e.g., a 5G or NR PSS/SSS transmitted in accordance with the 5G/NR cellular technology). A first subset of broadcast channel resources may also be configured and associated with the first cellular technology. For example, the first subset of broadcast channel resources may include a 5G PBCH 315 resources that are used to carry or otherwise convey 5G PBCH payload and 5G PBCH DMRS signaling.

The UE may receive a broadcast message via a second subset of broadcast channel resources that are associated with a second cellular technology. For example, the second subset of broadcast channel resources may include 6G PBCH 320 resources that are configured to carry 6G PBCH payload and 6G PBCH DMRS signaling. Thus, the SSB illustrated in accordance with spectrum sharing scheme 300 may include 5G/NR PSS/SSS signaling resources, 5G/NR PBCH signaling resources, and 6G PBCH resources. The 6G PHCH resources may be appended to the 5G SSB resources such that both 5G and 6G UE may be able to use the same SSB for channel access, synchronization, RRM, and other functions, with the network entity. Spectrum sharing scheme 300 illustrates non-limiting examples of where and how the 5G/6G SSB may be configured or otherwise allocated within the carrier. That is, depending on the location of the SSB within the carrier bandwidth, the 6G PBCH resource extension to carry the 6G PBCH payload/DMRS may be configured or otherwise allocated differently. It is to be understood that these configurations/allocations are shown by way of non-limiting example only.

That is, the frequency resources for the SSB that includes the 5G/NR PSS/SSS (the synchronization channel resources), the 5G/NR PBCH (the first subset of broadcast channel resources), and the 6G PBCH (the second subset of broadcast channel resources) may be located at a specific location within the carrier bandwidth of the UE. In some examples, the relative position in the frequency domain between the 5G PBCH resources and the 6G PBCH resources may be based on the location of the SSB within the carrier bandwidth.

Spectrum sharing scheme 300-a of FIG. 3A illustrates a non-limiting example of where the SSB is located relatively in the center of the carrier bandwidth frequency domain. In this example where the location of the SSB is relatively centered within the carrier bandwidth, the relative position in the frequency domain for the first subset of broadcast channel resources and the second subset of broadcast channel resources may be based on or otherwise in accordance with the location. In this example, this may include the 6G PBCH 320 resources being extended to both ends (e.g., in the frequency domain) of the 5G PBCH 315 resources. For example, a first portion of the second subset of broadcast channel resources (e.g., some of the 6G PBCH 320 resources) may be extended or added in higher frequency resources relative to the first subset of broadcast channel resources (e.g., the 5G PBCH 315 resources) and a second portion of the second subset of broadcast channel resources (e.g., the remaining 6G PBCH 320 resources) may be extended or added in lower frequency resources relative to the first subset of broadcast channel resources.

Spectrum sharing scheme 300-b of FIG. 3B illustrates a non-limiting example of where the SSB is located relatively in the bottom of the carrier bandwidth frequency domain (e.g., starting at the lowest frequency within the carrier bandwidth). In this example where the location of the SSB is relatively at the bottom or in the lowest frequency resources within the carrier bandwidth, the relative position in the frequency domain for the first subset of broadcast channel resources and the second subset of broadcast channel resources may be based on or otherwise in accordance with the location. In this example, this may include the 6G PBCH 320 resources being extended above (e.g., in higher frequency resources) the 5G PBCH 315 frequency resources.

Spectrum sharing scheme 300-c of FIG. 3C illustrates a non-limiting example of where the SSB is located relatively in the top of the carrier bandwidth frequency domain (e.g., starting at the highest frequency within the carrier bandwidth). In this example where the location of the SSB is relatively at the top or in the highest frequency resources within the carrier bandwidth, the relative position in the frequency domain for the first subset of broadcast channel resources and the second subset of broadcast channel resources may be based on or otherwise in accordance with the location. In this example, this may include the 6G PBCH 320 resources being extended below (e.g., in lower frequency resources) than the 5G PBCH 315 frequency resources.

Spectrum sharing scheme 300-b of FIG. 3B and spectrum sharing scheme 300-c of FIG. 3C illustrate non-limiting examples that enable the location of the NR SSB with the 6G PBCH resource extension at the edge of the carrier bandwidth.

Before a 6G UE decodes information carried by a message/payload (e.g., PBCH message, system information, higher layer message, or other message), the UE may be unaware of the carrier bandwidth and the location of the NR SSB. For example, when the 6G UE detects the PSS/SSS and possible the NR PBCH, in some examples, the UE may not know whether the NR SSB is located at the edge of the carrier or in the middle. Accordingly, various techniques are described that may support the 6G UE using the NR SSB including the 6G PBCH 320 resource extension to determine the SSB index, which may then be used to identify or otherwise determine additional configuration information for the cell/beam corresponding to the SSB index.

One option may include the 6G UE attempting to decode/demodulate the 6G PBCH (e.g., the broadcast message) using multiple hypothesis of the extended resource location relative to the PSS/SSS or NR PBCH. For example, the UE may perform blind decoding attempt(s) of the broadcast message using a relative position hypothesis in the frequency domain for the 5G PBCH 315 resources and the 6G PBCH 320 resources. One hypothesis may be that, when the NR SSB with the 6G PBCH resource extension is located in the middle of the carrier bandwidth (e.g., the NR SSB location is within a threshold of the carrier bandwidth center frequency), the 6G PBCH 320 resources may be extended above and below the 5G PBCH 315 resources, as shown in spectrum sharing scheme 300-a of FIG. 3A.

Another hypothesis may be that, when the NR SSB with the 6G PBCH 320 resource extension is located at the bottom of the carrier bandwidth (e.g., the NR SSB location is located at a lowest available frequency resources within the carrier bandwidth), the 6G PBCH 320 resources may be extended above the 5G PBCH 315 resources, as shown in spectrum sharing scheme 300-b of FIG. 3B. Yet another hypothesis may be that, when the NR SSB with the 6G PBCH 320 resource extension is located at the top of the carrier bandwidth (e.g., the NR SSB location is located at a highest available frequency resources within the carrier bandwidth), the 6G PBCH 320 resources may be extended below the 5G PBCH 315 resources, as shown in spectrum sharing scheme 300-c of FIG. 3C. A successful blind decoding attempt of the broadcast message carried in the 6G PBCH 320 resources may indicate that the 6G UE is now able to successfully recover some or all of the SSB index of the NR SSB.

Another option may be that the relative position hypothesis is implicitly indicated to the 6G UE by available information before the UE attempts to process the extended resources (e.g., the broadcast message). For example, the UE may receive or otherwise obtain information identifying the relative position hypothesis in the frequency domain for the NR SSB with the 6G PBCH resource extension. Again, the relative position hypothesis may carry or otherwise provide an indication of the relative position of the 6G PBCH 320 resources relative to the 5G PBCH 315 resources in the frequency domain. Indicating the relative position hypothesis information to the UE beforehand may reduce the number of decoding attempts the UE may use to recover the 6G PBCH payload or the 6G PBCH DMRS.

Various techniques may be applied to implicitly indicate the information identifying the relative position hypothesis to the UE. One technique may be based on a mapping between an identifier of the synchronization message and the relative position hypothesis. For example, the UE may be configured with or otherwise determine a mapping between the identifiers of the PSS/SSS (e.g., PSS 305 or SSS 310) and the hypothesis of the extended resource location. As one non-limiting example, PSS/SSS identifiers of (0, 3, 6, . . . ) may be mapped to a first relative position hypothesis, identifiers of (1, 4, 7, . . . ) may be mapped to a second relative position hypothesis, and identifiers of (2, 5, 8, . . . ) may be mapped to a third relative position hypothesis. Accordingly, the 6G UE receiving the synchronization message (NR PSS/SSS) may use the identifier of the synchronization message to select which hypothesis to use to attempt to decode the broadcast message.

Another technique may be based on a mapping between a synchronization raster of the synchronization channel resources and the relative position hypothesis of the UE. For example, the UE may be configured with or otherwise determine a mapping between the global synchronization channel number (GSCN) values and the hypotheses of the extended resource location. For example, the synchronization rasters may be divided into three groups. A relative position hypothesis may be mapped to each synchronization raster group. For a given synchronization raster, the 6G UE may assume one of the relative position hypothesis (e.g., the hypothesis mapped to the given synchronization raster) and attempt to decode the broadcast message (e.g., 6G PBCH payload or 6G PBCH DMRS) once the PSS/SSS is detected.

Another technique may be based on a mapping between the frequency band in which the PSS/SSS is detected and the relative position hypothesis of the UE. That is, a set of hypotheses may depend on the frequency band or frequency range that the UE is search for the NR SSB. One or a small number of relative position hypotheses may be configured for a given frequency range or band.

In some examples, one or more of these techniques may be used in combination to further signal the relative position hypothesis to the UE in order to reduce the number of decoding attempts for the broadcast message carried in the 6G PBCH 320 resources.

Accordingly, the 6G UE may recover the broadcast message from the 6G PBCH 320 resources and use this information for communications with the network entity using the 5G cellular technology, the 6G cellular technology, or both technologies.

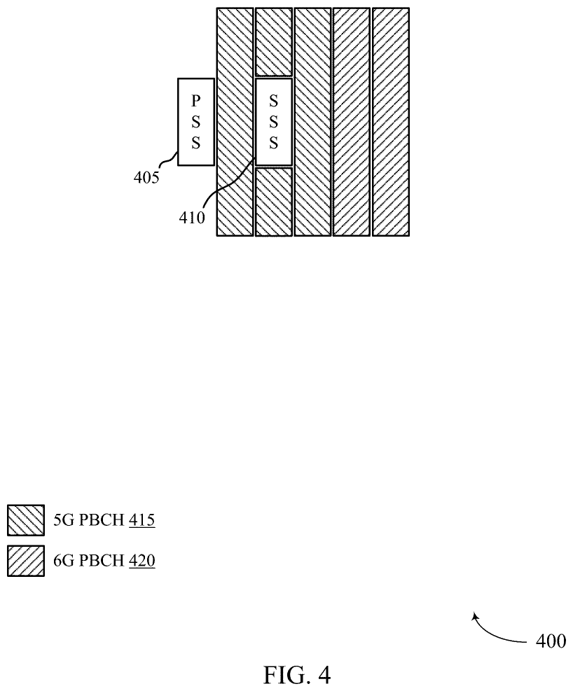

FIG. 4 shows an example of a spectrum sharing scheme 400 that supports spectrum sharing between different cellular technologies in accordance with one or more aspects of the present disclosure. Spectrum sharing scheme 400 may implement aspects of wireless communications system 100, aspects of wireless communications system 200, or aspects of spectrum sharing scheme 300. Aspects of spectrum sharing scheme 400 may be implemented at or implemented by a UE or a network entity, which may be examples of the corresponding devices described herein.

The techniques described herein generally provide for extension of the SSB resources to support both 5G (a first cellular technology) and 6G (a second cellular technology) UE. That is, the UE may receive a synchronization message from a network entity via synchronization channel resources. The synchronization message may include one or both of a PSS 405 or a SSS 410. The synchronization message may be a PSS/SSS signal in accordance with the first cellular technology (e.g., a 5G or NR PSS/SSS transmitted in accordance with the 5G/NR cellular technology). A first subset of broadcast channel resources may also be configured and associated with the first cellular technology. For example, the first subset of broadcast channel resources may include a 5G PBCH 415 resources that are used to carry or otherwise convey 5G PBCH payload and 5G PBCH DMRS signaling.

The UE may receive a broadcast message via a second subset of broadcast channel resources that are associated with a second cellular technology. For example, the second subset of broadcast channel resources may include 6G PBCH 420 resources that are configured to carry 6G PBCH payload and 6G PBCH DMRS signaling. Thus, the SSB illustrated in accordance with spectrum sharing scheme 400 may include 5G/NR PSS/SSS signaling resources, 5G/NR PBCH signaling resources, and 6G PBCH resources. The 6G PHCH resources may be appended to the 5G SSB resources such that both 5G and 6G UE may be able to use the same SSB for channel access, synchronization, RRM, and other functions, with the network entity. Spectrum sharing scheme 400 illustrates another non-limiting examples of where and how the 5G/6G SSB may be configured or otherwise allocated within the carrier.

That is, the spectrum sharing scheme 400 illustrates a non-limiting example of were the first subset of broadcast channel resources (e.g., the 5G PBCH 415 resources) and the second subset of broadcast channel resources (e.g., the 6G PBCH 420 resources) are configured as non-overlapping resources in the time domain. More particularly, in the examples discussed with reference to wireless communications system 200 of FIG. 2 and to spectrum sharing scheme 300 of FIG. 3, the 6G PBCH resource extension is configured or otherwise allocated in the same time domain (e.g., in overlapping or the same symbols), but in different frequency resources (e.g., non-overlapping frequency resources). However, spectrum sharing scheme 400 illustrates a non-limiting example of where the 6G PBCH resources can be appended to the symbol(s) following the 5G/NR PSS/SSS and 5G/NR PBCH resources (e.g., in non-overlapping time resources, but in overlapping or the same frequency resources). In some examples, this may reduce the number of beams (e.g., when operating in FR2) used for SSB transmissions in the carrier. For example, back-to-back SSBs may not be configured with the 6G PBCH 420 resource extension in the time domain.

As wireless networks develop, the spectrum sharing may be no longer needed. For example, as 5G support expires within the wireless network, some or all of the 5G PBCH resources may be repurposed (e.g., replaced with) for 6G PBCH resources. In some examples, whether the extended resources for 6G PBCH are outside of the NR PBCH resources or replaces the NR PBCH resources may be identified or otherwise determined based on the techniques discussed above (such as based on various mappings or using dedicated signaling). In some examples where the 5G PBCH resources are used for 6G PBCH transmissions, the NR PBCH DMRS may be maintained within the 6G PBCH resources. For example, the NR PBCH DMRS sequence initialization for the 5G PBCH DMRS may be used to indicate some or all of the bits of the SSB index.

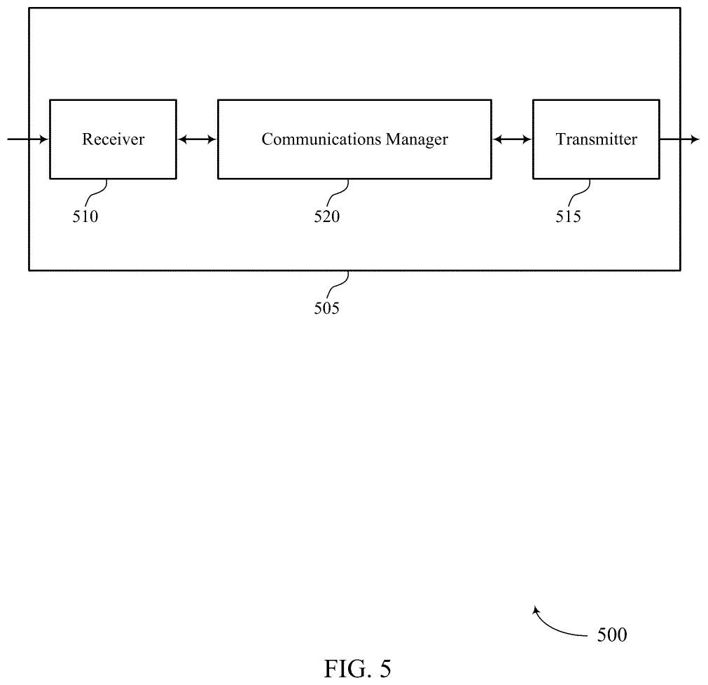

FIG. 5 shows a block diagram 500 of a device 505 that supports spectrum sharing between different cellular technologies in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include one or more processors, memory coupled with the one or more processors, and instructions stored in the memory that are executable by the one or more processors to perform the spectrum sharing features discussed herein. Each of these components may be in communication with one another (e.g., via one or more buses).

The receiver 510 may provide a means for receiving information such as packets, user data, control information, or any combination thereof associated with various information channels (e.g., control channels, data channels, information channels related to 5G-6G spectrum sharing). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to spectrum sharing between cellular technologies). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of 5G-6G spectrum sharing as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, via a set of synchronization channel resources, a synchronization message from a network entity, where the set of synchronization channel resources and a first subset of broadcast channel resources are both associated with a first cellular technology. The communications manager 520 is capable of, configured to, or operable to support a means for receiving, via a second subset of broadcast channel resources and according to the synchronization message, a broadcast message from the network entity, the second subset of broadcast channel resources associated with a second cellular technology that is different from the first cellular technology. The communications manager 520 is capable of, configured to, or operable to support a means for communicating with the network entity using the first cellular technology, the second cellular technology, or both, in accordance with the synchronization message and the broadcast message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for extending 5G/NR SSB resources to include 6G PBCH resources to support spectrum sharing frequency reuse to improve efficiency.

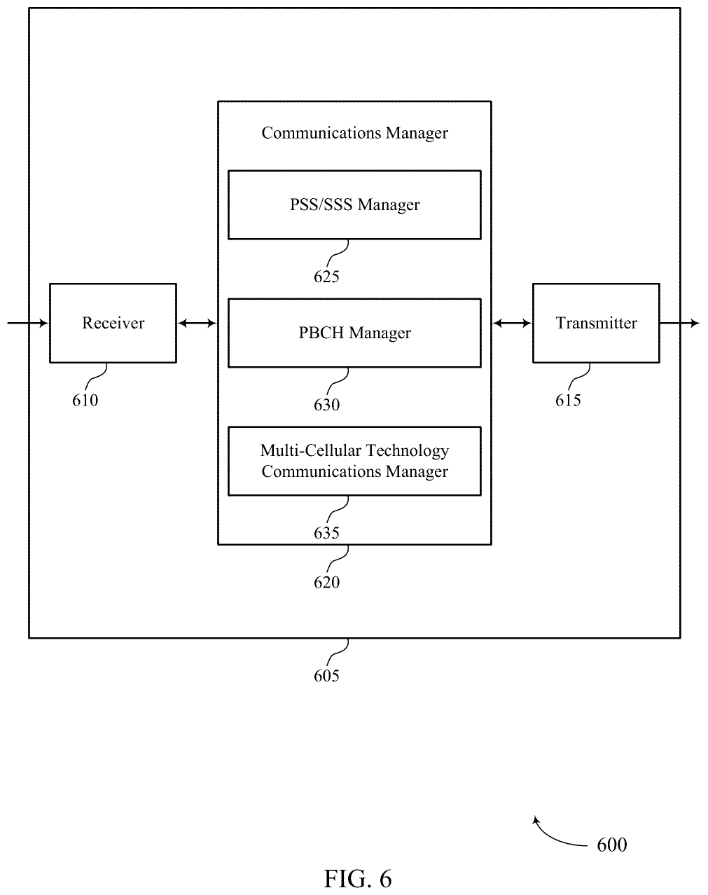

FIG. 6 shows a block diagram 600 of a device 605 that supports spectrum sharing between different cellular technologies in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to 5G-6G spectrum sharing). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to spectrum sharing between cellular technologies). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of 5G-6G spectrum sharing as described herein. For example, the communications manager 620 may include an PSS/SSS manager 625, a PBCH manager 630, a multi-cellular technology communications manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The PSS/SSS manager 625 is capable of, configured to, or operable to support a means for receiving, via a set of synchronization channel resources, a synchronization message from a network entity, where the set of synchronization channel resources and a first subset of broadcast channel resources are both associated with a first cellular technology. The PBCH manager 630 is capable of, configured to, or operable to support a means for receiving, via a second subset of broadcast channel resources and according to the synchronization message, a broadcast message from the network entity, the second subset of broadcast channel resources associated with a second cellular technology that is different from the first cellular technology. The multi-cellular technology communications manager 635 is capable of, configured to, or operable to support a means for communicating with the network entity using the first cellular technology, the second cellular technology, or both, in accordance with the synchronization message and the broadcast message.

In some cases, the PSS/SSS manager 625, the PBCH manager 630, and the multi-cellular technology communications manager 635 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the PSS/SSS manager 625, the PBCH manager 630, the multi-cellular technology communications manager 635 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

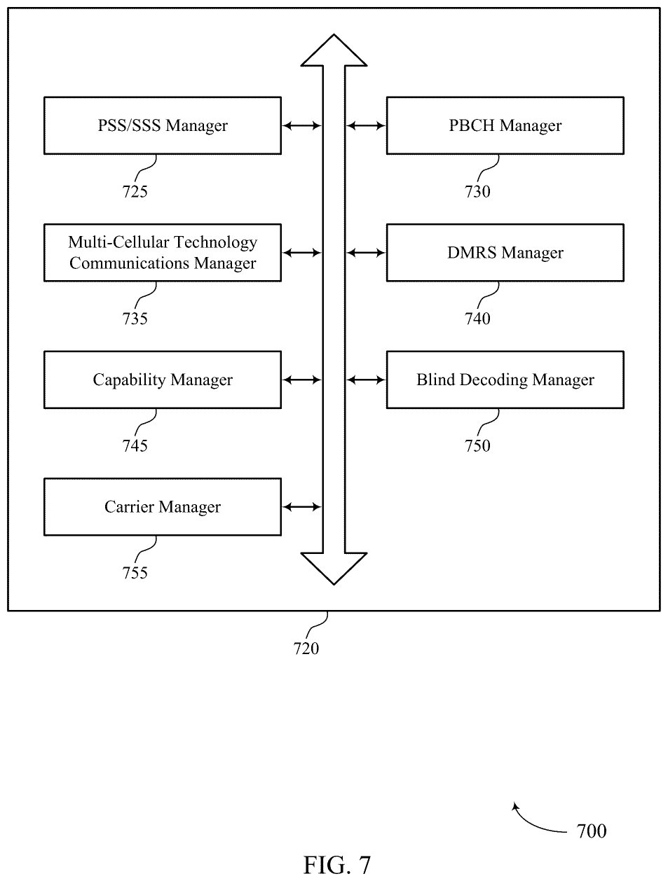

FIG. 7 shows a block diagram 700 of a communications manager 720 that supports spectrum sharing between different cellular technologies in accordance with one or more aspects of the present disclosure. The communications manager 720 may be an example of aspects of a communications manager 520, a communications manager 620, or both, as described herein. The communications manager 720, or various components thereof, may be an example of means for performing various aspects of spectrum sharing as described herein. For example, the communications manager 720 may include an PSS/SSS manager 725, a PBCH manager 730, a multi-cellular technology communications manager 735, a DMRS manager 740, a capability manager 745, a blind decoding manager 750, a carrier manager 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The PSS/SSS manager 725 is capable of, configured to, or operable to support a means for receiving, via a set of synchronization channel resources, a synchronization message from a network entity, where the set of synchronization channel resources and a first subset of broadcast channel resources are both associated with a first cellular technology. The PBCH manager 730 is capable of, configured to, or operable to support a means for receiving, via a second subset of broadcast channel resources and according to the synchronization message, a broadcast message from the network entity, the second subset of broadcast channel resources associated with a second cellular technology that is different from the first cellular technology. The multi-cellular technology communications manager 735 is capable of, configured to, or operable to support a means for communicating with the network entity using the first cellular technology, the second cellular technology, or both, in accordance with the synchronization message and the broadcast message.

In some examples, the DMRS manager 740 is capable of, configured to, or operable to support a means for receiving, via the first subset of broadcast channel resources, a demodulation reference signal associated with the first cellular technology, where receiving the broadcast message using the second cellular technology is in accordance with the demodulation reference signal.

In some examples, to support receiving the synchronization message, the DMRS manager 740 is capable of, configured to, or operable to support a means for receiving a first portion of a synchronization signal block (SSB) index in accordance with the demodulation reference signal. In some examples, to support receiving the synchronization message, the DMRS manager 740 is capable of, configured to, or operable to support a means for receiving a second portion of the SSB index in accordance with the broadcast message.

In some examples, the capability manager 745 is capable of, configured to, or operable to support a means for transmitting a capability message indicating UE support for using a demodulation reference signal associated with the first cellular technology to receive the broadcast message, where receiving the broadcast message is in accordance with the capability message. In some examples, a location of the first subset of broadcast channel resources, the second subset of broadcast channel resources, or both, is within a carrier bandwidth associated with the UE. In some examples, a relative position in a frequency domain for the first subset of broadcast channel resources and the second subset of broadcast channel resources is defined with respect to the location.

In some examples, the blind decoding manager 750 is capable of, configured to, or operable to support a means for performing one or more blind decoding attempts of the broadcast message using a set of relative position hypotheses in a frequency domain for the first subset of broadcast channel resources and the second subset of broadcast channel resources. In some examples, a SSB index associated with the first subset of broadcast channel resources and the second subset of broadcast channel resources is identified based on a successful blind decoding attempt.

In some examples, the carrier manager 755 is capable of, configured to, or operable to support a means for receiving information identifying a relative position hypothesis in a frequency domain for the first subset of broadcast channel resources and the second subset of broadcast channel resources. In some examples, the carrier manager 755 is capable of, configured to, or operable to support a means for decoding the broadcast message in accordance with the relative position hypothesis. In some examples, the information includes a first mapping between an identifier associated with the synchronization message and the relative position hypothesis, a second mapping between a synchronization raster associated with the set of synchronization channel resources and the relative position hypothesis, a third mapping between a frequency band associated with the set of synchronization channel resources and the relative position hypothesis, or a combination thereof.

In some examples, the first subset of broadcast channel resources and the second subset of broadcast channel resources include overlapping time resources or non-overlapping time resources. In some examples, the broadcast message indicates time and frequency resources for the communicating with the network entity in accordance with the first cellular technology, the second cellular technology, or both.

In some cases, the PSS/SSS manager 725, the PBCH manager 730, the multi-cellular technology communications manager 735, the DMRS manager 740, the capability manager 745, the blind decoding manager 750, and the carrier manager 755 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the PSS/SSS manager 725, the PBCH manager 730, the multi-cellular technology communications manager 735, the DMRS manager 740, the capability manager 745, the blind decoding manager 750, and the carrier manager 755 discussed herein.

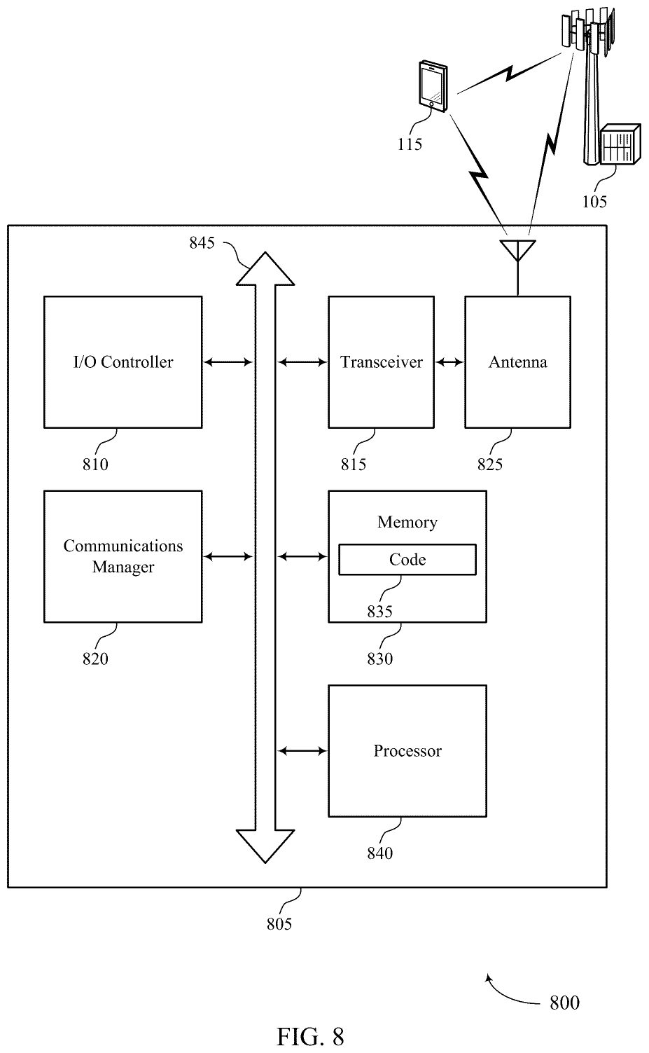

FIG. 8 shows a diagram of a system 800 including a device 805 that supports spectrum sharing between different cellular technologies in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting 5G-6G spectrum sharing). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, via a set of synchronization channel resources, a synchronization message from a network entity, where the set of synchronization channel resources and a first subset of broadcast channel resources are both associated with a first cellular technology. The communications manager 820 is capable of, configured to, or operable to support a means for receiving, via a second subset of broadcast channel resources and according to the synchronization message, a broadcast message from the network entity, the second subset of broadcast channel resources associated with a second cellular technology that is different from the first cellular technology. The communications manager 820 is capable of, configured to, or operable to support a means for communicating with the network entity using the first cellular technology, the second cellular technology, or both, in accordance with the synchronization message and the broadcast message.

By including or configuring the communications manager 820 in accordance with examples as described herein, the device 805 may support techniques for extending 5G/NR SSB resources to include 6G PBCH resources to support spectrum sharing frequency reuse to improve efficiency.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of spectrum sharing as described herein, or the at least one processor 840 and the at least one memory 830 may be otherwise configured to, individually or collectively, perform or support such operations.

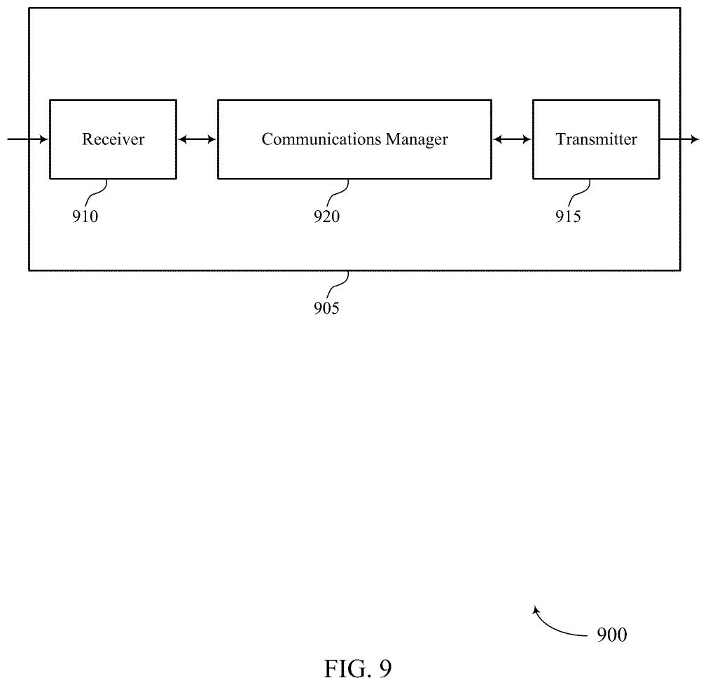

FIG. 9 shows a block diagram 900 of a device 905 that supports spectrum sharing between different cellular technologies in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include one or more processors, memory coupled with the one or more processors, and instructions stored in the memory that are executable by the one or more processors to enable the one or more processors to perform the spectrum sharing features discussed herein. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of spectrum sharing as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting, via a set of synchronization channel resources, a synchronization message to a UE, where the set of synchronization channel resources and a first subset of broadcast channel resources are both associated with a first cellular technology. The communications manager 920 is capable of, configured to, or operable to support a means for outputting, via a second subset of broadcast channel resources and according to the synchronization message, a broadcast message from the network entity, the second subset of broadcast channel resources associated with a second cellular technology that is different from the first cellular technology. The communications manager 920 is capable of, configured to, or operable to support a means for communicating with the UE using the first cellular technology, the second cellular technology, or both, in accordance with the synchronization message and the broadcast message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for extending 5G/NR SSB resources to include 6G PBCH resources to support spectrum sharing frequency reuse to improve efficiency.

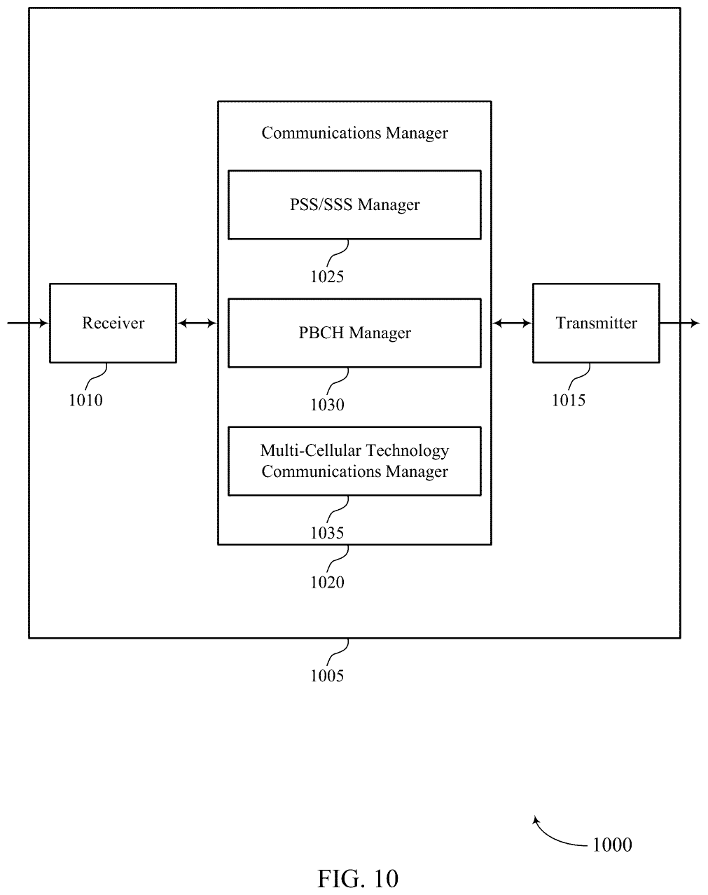

FIG. 10 shows a block diagram 1000 of a device 1005 that supports spectrum sharing between different cellular technologies in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of spectrum sharing as described herein. For example, the communications manager 1020 may include an PSS/SSS manager 1025, a PBCH manager 1030, a multi-cellular technology communications manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The PSS/SSS manager 1025 is capable of, configured to, or operable to support a means for outputting, via a set of synchronization channel resources, a synchronization message to a UE, where the set of synchronization channel resources and a first subset of broadcast channel resources are both associated with a first cellular technology. The PBCH manager 1030 is capable of, configured to, or operable to support a means for outputting, via a second subset of broadcast channel resources and according to the synchronization message, a broadcast message from the network entity, the second subset of broadcast channel resources associated with a second cellular technology that is different from the first cellular technology. The multi-cellular technology communications manager 1035 is capable of, configured to, or operable to support a means for communicating with the UE using the first cellular technology, the second cellular technology, or both, in accordance with the synchronization message and the broadcast message.

In some cases, the PSS/SSS manager 1025, the PBCH manager 1030, and the multi-cellular technology communications manager 1035 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the PSS/SSS manager 1025, the PBCH manager 1030, and the multi-cellular technology communications manager 1035 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

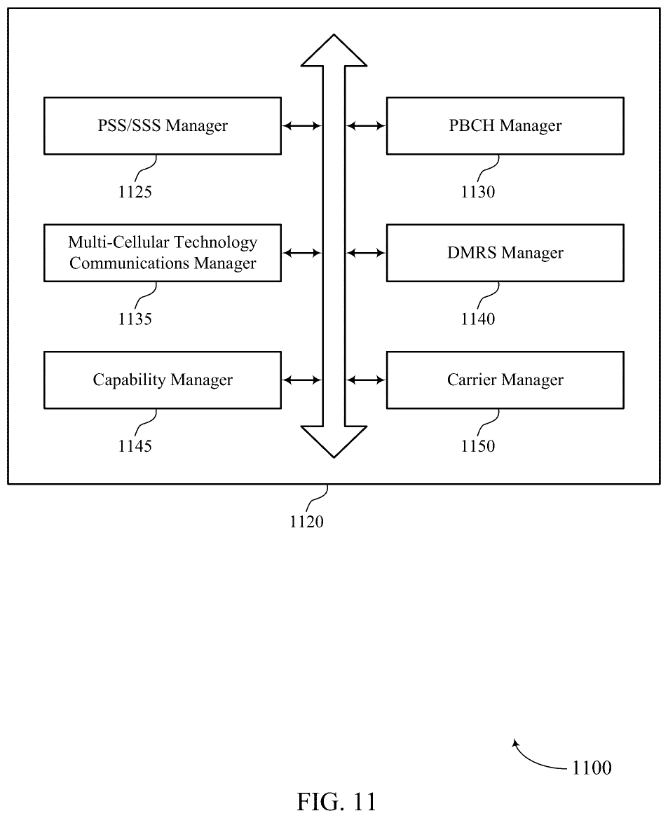

FIG. 11 shows a block diagram 1100 of a communications manager 1120 that supports spectrum sharing between different cellular technologies in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of spectrum sharing as described herein. For example, the communications manager 1120 may include an PSS/SSS manager 1125, a PBCH manager 1130, a multi-cellular technology communications manager 1135, a DMRS manager 1140, a capability manager 1145, a carrier manager 1150, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The PSS/SSS manager 1125 is capable of, configured to, or operable to support a means for outputting, via a set of synchronization channel resources, a synchronization message to a UE, where the set of synchronization channel resources and a first subset of broadcast channel resources are both associated with a first cellular technology. The PBCH manager 1130 is capable of, configured to, or operable to support a means for outputting, via a second subset of broadcast channel resources and according to the synchronization message, a broadcast message from the network entity, the second subset of broadcast channel resources associated with a second cellular technology that is different from the first cellular technology. The multi-cellular technology communications manager 1135 is capable of, configured to, or operable to support a means for communicating with the UE using the first cellular technology, the second cellular technology, or both, in accordance with the synchronization message and the broadcast message.

In some examples, the DMRS manager 1140 is capable of, configured to, or operable to support a means for outputting, via the first subset of broadcast channel resources, a demodulation reference signal associated with the first cellular technology, where outputting the broadcast message using the second cellular technology is in accordance with the demodulation reference signal. In some examples, a first portion of a SSB index is identified in accordance with the demodulation reference signal and a second portion of the SSB index is identified in accordance with the broadcast message.

In some examples, the capability manager 1145 is capable of, configured to, or operable to support a means for obtaining a capability message indicating UE support for using a demodulation reference signal associated with the first cellular technology to receive the broadcast message, where outputting the broadcast message is in accordance with the capability message. In some examples, a location of the first subset of broadcast channel resources, the second subset of broadcast channel resources, or both, is within a carrier bandwidth associated with the UE. In some examples, a relative position in a frequency domain for the first subset of broadcast channel resources and the second subset of broadcast channel resources is defined with respect to the location.

In some examples, the carrier manager 1150 is capable of, configured to, or operable to support a means for outputting information to the UE identifying a relative position hypothesis in a frequency domain for the first subset of broadcast channel resources and the second subset of broadcast channel resources, where the UE decodes the broadcast message in accordance with the relative position hypothesis.

In some examples, the information includes a first mapping between an identifier associated with the synchronization message and the relative position hypothesis, a second mapping between a synchronization raster associated with the set of synchronization channel resources and the relative position hypothesis, a third mapping between a frequency band associated with the set of synchronization channel resources and the relative position hypothesis, or a combination thereof. In some examples, the first subset of broadcast channel resources and the second subset of broadcast channel resources include overlapping time resources or non-overlapping time resources. In some examples, the broadcast message indicates time and frequency resources for the communicating with the network entity in accordance with the first cellular technology, the second cellular technology, or both.

In some cases, the PSS/SSS manager 1125, the PBCH manager 1130, the multi-cellular technology communications manager 1135, the DMRS manager 1140, and the capability manager 1145, a carrier manager 1150 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the PSS/SSS manager 1125, the PBCH manager 1130, the multi-cellular technology communications manager 1135, the DMRS manager 1140, and the capability manager 1145, a carrier manager 1150 discussed herein.

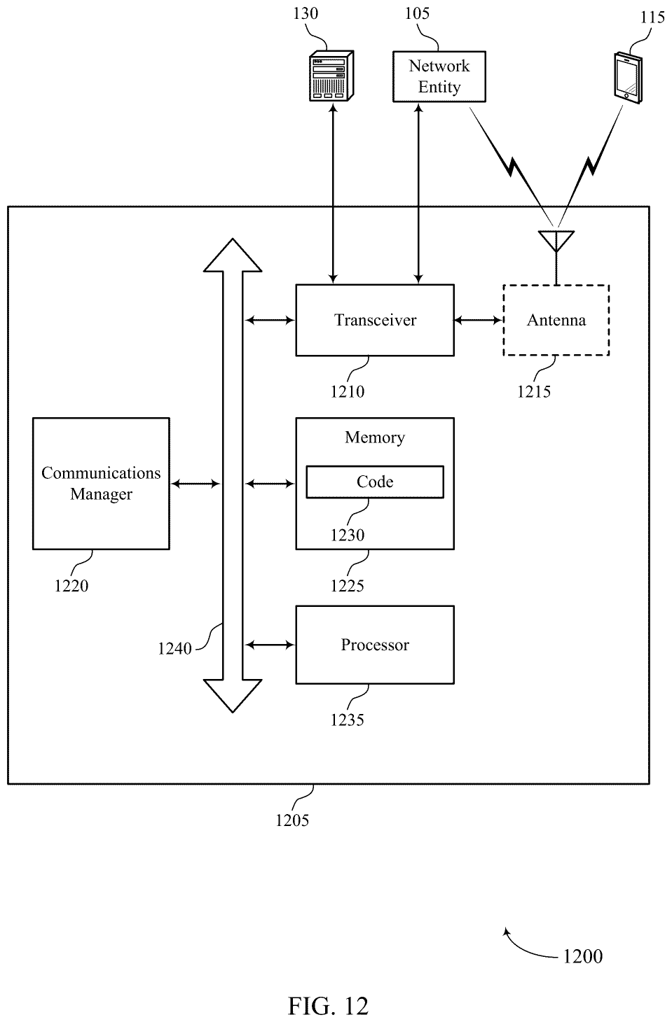

FIG. 12 shows a diagram of a system 1200 including a device 1205 that supports spectrum sharing between different cellular technologies in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting spectrum sharing between different cellular technologies, such as spectrum sharing between 5G and 6G). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting, via a set of synchronization channel resources, a synchronization message to a UE, where the set of synchronization channel resources and a first subset of broadcast channel resources are both associated with a first cellular technology. The communications manager 1220 is capable of, configured to, or operable to support a means for outputting, via a second subset of broadcast channel resources and according to the synchronization message, a broadcast message from the network entity, the second subset of broadcast channel resources associated with a second cellular technology that is different from the first cellular technology. The communications manager 1220 is capable of, configured to, or operable to support a means for communicating with the UE using the first cellular technology, the second cellular technology, or both, in accordance with the synchronization message and the broadcast message.

By including or configuring the communications manager 1220 in accordance with examples as described herein, the device 1205 may support techniques for extending 5G/NR SSB resources to include 6G PBCH resources to support spectrum sharing frequency reuse to improve efficiency.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of spectrum sharing between different cellular technologies as described herein, or the at least one processor 1235 and the at least one memory 1225 may be otherwise configured to, individually or collectively, perform or support such operations.

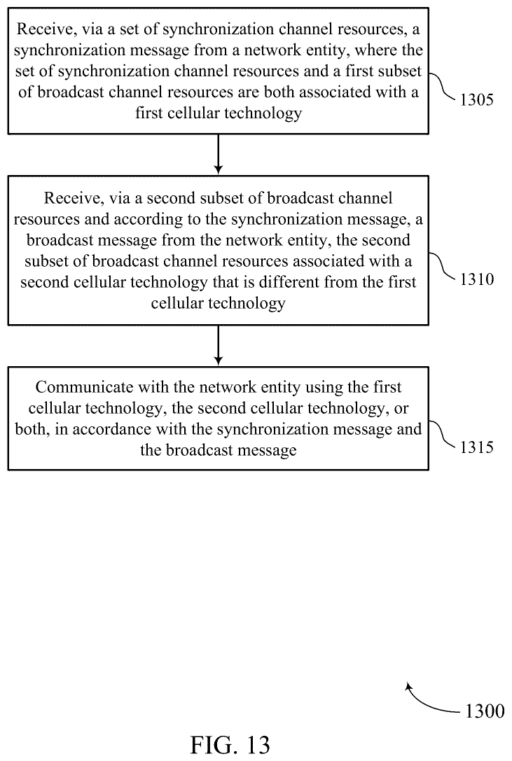

FIG. 13 shows a flowchart illustrating a method 1300 that supports spectrum sharing between different cellular technologies in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, via a set of synchronization channel resources, a synchronization message from a network entity, where the set of synchronization channel resources and a first subset of broadcast channel resources are both associated with a first cellular technology. The operations of block 1305 may be performed in accordance with examples as disclosed herein. In some examples, aspects of the operations of 1305 may be performed by an PSS/SSS manager 725 as described with reference to FIG. 7.

At 1310, the method may include receiving, via a second subset of broadcast channel resources and according to the synchronization message, a broadcast message from the network entity, the second subset of broadcast channel resources associated with a second cellular technology that is different from the first cellular technology. The operations of block 1310 may be performed in accordance with examples as disclosed herein. In some examples, aspects of the operations of 1310 may be performed by a PBCH manager 730 as described with reference to FIG. 7.

At 1315, the method may include communicating with the network entity using the first cellular technology, the second cellular technology, or both, in accordance with the synchronization message and the broadcast message. The operations of block 1315 may be performed in accordance with examples as disclosed herein. In some examples, aspects of the operations of 1315 may be performed by a multi-cellular technology communications manager 735 as described with reference to FIG. 7.

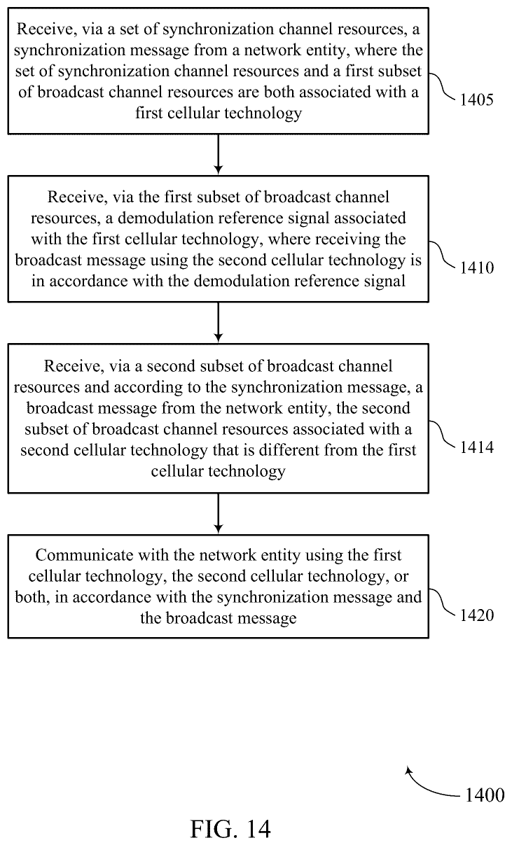

FIG. 14 shows a flowchart illustrating a method 1400 that supports spectrum sharing between different cellular technologies in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, via a set of synchronization channel resources, a synchronization message from a network entity, where the set of synchronization channel resources and a first subset of broadcast channel resources are both associated with a first cellular technology. The operations of block 1405 may be performed in accordance with examples as disclosed herein. In some examples, aspects of the operations of 1405 may be performed by an PSS/SSS manager 725 as described with reference to FIG. 7.

At 1410, the method may include receiving, via the first subset of broadcast channel resources, a demodulation reference signal associated with the first cellular technology, where receiving the broadcast message using the second cellular technology is in accordance with the demodulation reference signal. The operations of block 1410 may be performed in accordance with examples as disclosed herein. In some examples, aspects of the operations of 1410 may be performed by a DMRS manager 740 as described with reference to FIG. 7.

At 1415, the method may include receiving, via a second subset of broadcast channel resources and according to the synchronization message, a broadcast message from the network entity, the second subset of broadcast channel resources associated with a second cellular technology that is different from the first cellular technology. The operations of block 1415 may be performed in accordance with examples as disclosed herein. In some examples, aspects of the operations of 1415 may be performed by a PBCH manager 730 as described with reference to FIG. 7.

At 1420, the method may include communicating with the network entity using the first cellular technology, the second cellular technology, or both, in accordance with the synchronization message and the broadcast message. The operations of block 1420 may be performed in accordance with examples as disclosed herein. In some examples, aspects of the operations of 1420 may be performed by a multi-cellular technology communications manager 735 as described with reference to FIG. 7.

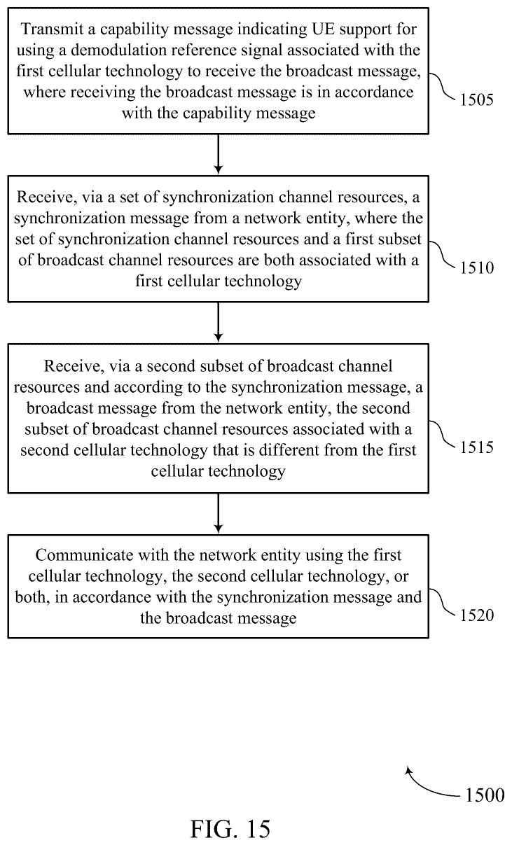

FIG. 15 shows a flowchart illustrating a method 1500 that supports spectrum sharing between different cellular technologies in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting a capability message indicating UE support for using a demodulation reference signal associated with the first cellular technology to receive the broadcast message, where receiving the broadcast message is in accordance with the capability message. The operations of block 1505 may be performed in accordance with examples as disclosed herein. In some examples, aspects of the operations of 1505 may be performed by a capability manager 745 as described with reference to FIG. 7.

At 1510, the method may include receiving, via a set of synchronization channel resources, a synchronization message from a network entity, where the set of synchronization channel resources and a first subset of broadcast channel resources are both associated with a first cellular technology. The operations of block 1510 may be performed in accordance with examples as disclosed herein. In some examples, aspects of the operations of 1510 may be performed by an PSS/SSS manager 725 as described with reference to FIG. 7.

At 1515, the method may include receiving, via a second subset of broadcast channel resources and according to the synchronization message, a broadcast message from the network entity, the second subset of broadcast channel resources associated with a second cellular technology that is different from the first cellular technology. The operations of block 1515 may be performed in accordance with examples as disclosed herein. In some examples, aspects of the operations of 1515 may be performed by a PBCH manager 730 as described with reference to FIG. 7.

At 1520, the method may include communicating with the network entity using the first cellular technology, the second cellular technology, or both, in accordance with the synchronization message and the broadcast message. The operations of block 1520 may be performed in accordance with examples as disclosed herein. In some examples, aspects of the operations of 1520 may be performed by a multi-cellular technology communications manager 735 as described with reference to FIG. 7.

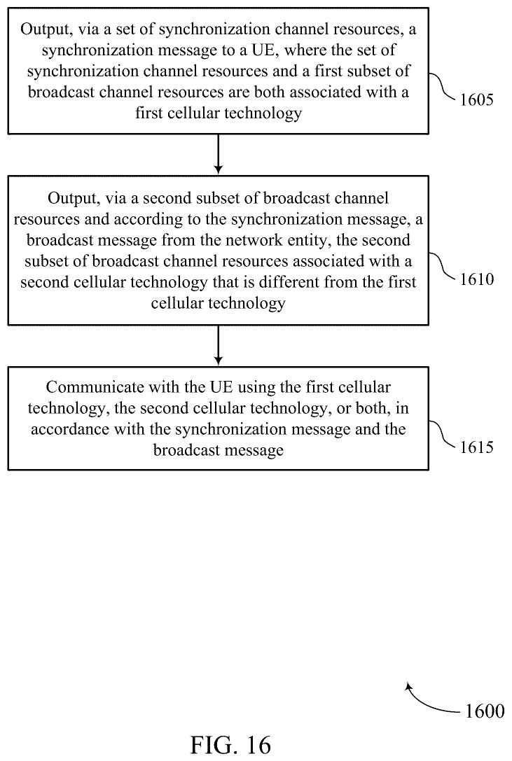

FIG. 16 shows a flowchart illustrating a method 1600 that supports spectrum sharing between different cellular technologies in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting, via a set of synchronization channel resources, a synchronization message to a UE, where the set of synchronization channel resources and a first subset of broadcast channel resources are both associated with a first cellular technology. The operations of block 1605 may be performed in accordance with examples as disclosed herein. In some examples, aspects of the operations of 1605 may be performed by an PSS/SSS manager 1125 as described with reference to FIG. 11.

At 1610, the method may include outputting, via a second subset of broadcast channel resources and according to the synchronization message, a broadcast message from the network entity, the second subset of broadcast channel resources associated with a second cellular technology that is different from the first cellular technology. The operations of block 1610 may be performed in accordance with examples as disclosed herein. In some examples, aspects of the operations of 1610 may be performed by a PBCH manager 1130 as described with reference to FIG. 11.

At 1615, the method may include communicating with the UE using the first cellular technology, the second cellular technology, or both, in accordance with the synchronization message and the broadcast message. The operations of block 1615 may be performed in accordance with examples as disclosed herein. In some examples, aspects of the operations of 1615 may be performed by a multi-cellular technology communications manager 1135 as described with reference to FIG. 11.

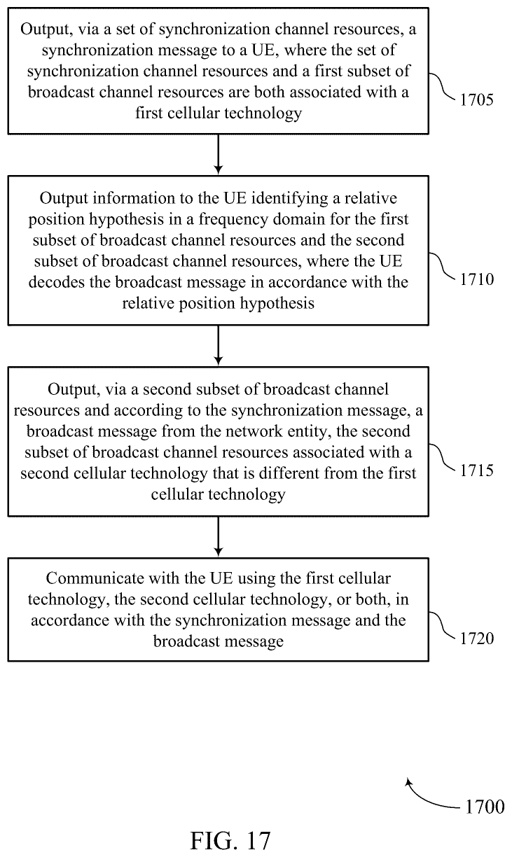

FIG. 17 shows a flowchart illustrating a method 1700 that supports spectrum sharing between different cellular technologies in accordance with aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include outputting, via a set of synchronization channel resources, a synchronization message to a UE, where the set of synchronization channel resources and a first subset of broadcast channel resources are both associated with a first cellular technology. The operations of block 1705 may be performed in accordance with examples as disclosed herein. In some examples, aspects of the operations of 1705 may be performed by an PSS/SSS manager 1125 as described with reference to FIG. 11.

At 1710, the method may include outputting information to the UE identifying a relative position hypothesis in a frequency domain for the first subset of broadcast channel resources and the second subset of broadcast channel resources, where the UE decodes the broadcast message in accordance with the relative position hypothesis. The operations of block 1710 may be performed in accordance with examples as disclosed herein. In some examples, aspects of the operations of 1710 may be performed by a carrier manager 1150 as described with reference to FIG. 11.

At 1715, the method may include outputting, via a second subset of broadcast channel resources and according to the synchronization message, a broadcast message from the network entity, the second subset of broadcast channel resources associated with a second cellular technology that is different from the first cellular technology. The operations of block 1715 may be performed in accordance with examples as disclosed herein. In some examples, aspects of the operations of 1715 may be performed by a PBCH manager 1130 as described with reference to FIG. 11.

At 1720, the method may include communicating with the UE using the first cellular technology, the second cellular technology, or both, in accordance with the synchronization message and the broadcast message. The operations of block 1720 may be performed in accordance with examples as disclosed herein. In some examples, aspects of the operations of 1720 may be performed by a multi-cellular technology communications manager 1135 as described with reference to FIG. 11.

The following provides an overview of aspects of the present disclosure:

Aspect 1: A method for wireless communications at a UE, comprising: receiving, via a set of synchronization channel resources, a synchronization message from a network entity, wherein the set of synchronization channel resources and a first subset of broadcast channel resources are both associated with a first cellular technology; receiving, via a second subset of broadcast channel resources and according to the synchronization message, a broadcast message from the network entity, the second subset of broadcast channel resources associated with a second cellular technology that is different from the first cellular technology; and communicating with the network entity using the first cellular technology, the second cellular technology, or both, in accordance with the synchronization message and the broadcast message.

Aspect 2: The method of aspect 1, further comprising: receiving, via the first subset of broadcast channel resources, a demodulation reference signal associated with the first cellular technology, wherein receiving the broadcast message using the second cellular technology is in accordance with the demodulation reference signal.

Aspect 3: The method of aspect 2, wherein receiving the synchronization message comprises: receiving a first portion of a synchronization signal block (SSB) index in accordance with the demodulation reference signal; and receiving a second portion of the SSB index in accordance with the broadcast message.

Aspect 4: The method of any of aspects 1 through 3, further comprising: transmitting a capability message indicating UE support for using a demodulation reference signal associated with the first cellular technology to receive the broadcast message, wherein receiving the broadcast message is in accordance with the capability message.

Aspect 5: The method of any of aspects 1 through 4, wherein a location of the first subset of broadcast channel resources, the second subset of broadcast channel resources, or both, is within a carrier bandwidth associated with the UE.

Aspect 6: The method of aspect 5, wherein a relative position in a frequency domain for the first subset of broadcast channel resources and the second subset of broadcast channel resources is defined with respect to the location.

Aspect 7: The method of any of aspects 1 through 6, further comprising: performing one or more blind decoding attempts of the broadcast message using a set of relative position hypotheses in a frequency domain for the first subset of broadcast channel resources and the second subset of broadcast channel resources.

Aspect 8: The method of aspect 7, wherein a synchronization signal block (SSB) index associated with the first subset of broadcast channel resources and the second subset of broadcast channel resources is identified based on a successful blind decoding attempt.

Aspect 9: The method of any of aspects 1 through 8, further comprising: receiving information identifying a relative position hypothesis in a frequency domain for the first subset of broadcast channel resources and the second subset of broadcast channel resources; and decoding the broadcast message in accordance with the relative position hypothesis.

Aspect 10: The method of aspect 9, wherein the information comprises a first mapping between an identifier associated with the synchronization message and the relative position hypothesis, a second mapping between a synchronization raster associated with the set of synchronization channel resources and the relative position hypothesis, a third mapping between a frequency band associated with the set of synchronization channel resources and the relative position hypothesis, or a combination thereof.

Aspect 11: The method of any of aspects 1 through 10, wherein the first subset of broadcast channel resources and the second subset of broadcast channel resources comprise overlapping time resources or non-overlapping time resources.

Aspect 12: The method of any of aspects 1 through 11, wherein the broadcast message indicates time and frequency resources for the communicating with the network entity in accordance with the first cellular technology, the second cellular technology, or both.

Aspect 13: A method for wireless communications at a network entity, comprising: outputting, via a set of synchronization channel resources, a synchronization message to a UE, wherein the set of synchronization channel resources and a first subset of broadcast channel resources are both associated with a first cellular technology; outputting, via a second subset of broadcast channel resources and according to the synchronization message, a broadcast message from the network entity, the second subset of broadcast channel resources associated with a second cellular technology that is different from the first cellular technology; and communicating with the UE using the first cellular technology, the second cellular technology, or both, in accordance with the synchronization message and the broadcast message.

Aspect 14: The method of aspect 13, further comprising: outputting, via the first subset of broadcast channel resources, a demodulation reference signal associated with the first cellular technology, wherein outputting the broadcast message using the second cellular technology is in accordance with the demodulation reference signal.

Aspect 15: The method of aspect 14, wherein a first portion of a synchronization signal block (SSB) index is identified in accordance with the demodulation reference signal and a second portion of the SSB index is identified in accordance with the broadcast message.

Aspect 16: The method of any of aspects 13 through 15, further comprising: obtaining a capability message indicating UE support for using a demodulation reference signal associated with the first cellular technology to receive the broadcast message, wherein outputting the broadcast message is in accordance with the capability message.

Aspect 17: The method of any of aspects 13 through 16, wherein a location of the first subset of broadcast channel resources, the second subset of broadcast channel resources, or both, is within a carrier bandwidth associated with the UE.

Aspect 18: The method of aspect 17, wherein a relative position in a frequency domain for the first subset of broadcast channel resources and the second subset of broadcast channel resources is defined with respect to the location.

Aspect 19: The method of any of aspects 13 through 18, further comprising: outputting information to the UE identifying a relative position hypothesis in a frequency domain for the first subset of broadcast channel resources and the second subset of broadcast channel resources, wherein the UE decodes the broadcast message in accordance with the relative position hypothesis.

Aspect 20: The method of aspect 19, wherein the information comprises a first mapping between an identifier associated with the synchronization message and the relative position hypothesis, a second mapping between a synchronization raster associated with the set of synchronization channel resources and the relative position hypothesis, a third mapping between a frequency band associated with the set of synchronization channel resources and the relative position hypothesis, or a combination thereof.

Aspect 21: The method of any of aspects 13 through 20, wherein the first subset of broadcast channel resources and the second subset of broadcast channel resources comprise overlapping time resources or non-overlapping time resources.

Aspect 22: The method of any of aspects 13 through 21, wherein the broadcast message indicates time and frequency resources for the communicating with the network entity in accordance with the first cellular technology, the second cellular technology, or both.

Aspect 23: A UE for wireless communications, comprising one or more memories storing processor-executable code, and one or more processors coupled with the one or more memories and individually or collectively operable to execute the code to cause the UE to perform a method of any of aspects 1 through 12.

Aspect 24: A UE for wireless communications, comprising at least one means for performing a method of any of aspects 1 through 12.

Aspect 25: A non-transitory computer-readable medium storing code for wireless communications, the code comprising instructions executable by one or more processors to perform a method of any of aspects 1 through 12.

Aspect 26: A network entity for wireless communications, comprising one or more memories storing processor-executable code, and one or more processors coupled with the one or more memories and individually or collectively operable to execute the code to cause the network entity to perform a method of any of aspects 13 through 22.

Aspect 27: A network entity for wireless communications, comprising at least one means for performing a method of any of aspects 13 through 22.

Aspect 28: A non-transitory computer-readable medium storing code for wireless communications, the code comprising instructions executable by one or more processors to perform a method of any of aspects 13 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories, wherein the one or more processors are individually or collectively configured to cause the UE to:
receive, via a set of synchronization channel resources, a synchronization message from a network entity, wherein the set of synchronization channel resources and a first subset of broadcast channel resources are both associated with a first cellular technology;
receive, via a second subset of broadcast channel resources and according to the synchronization message, a broadcast message from the network entity, the second subset of broadcast channel resources associated with a second cellular technology that is different from the first cellular technology; and
communicate with the network entity using the first cellular technology, the second cellular technology, or both, in accordance with the synchronization message and the broadcast message.

2. The UE of claim 1, wherein the one or more processors are individually or collectively further configured to cause the UE to:
receive, via the first subset of broadcast channel resources, a demodulation reference signal associated with the first cellular technology, wherein receiving the broadcast message using the second cellular technology is in accordance with the demodulation reference signal.

3. The UE of claim 2, wherein, to receive the synchronization message, the one or more processors are individually or collectively further configured to cause the UE to:
receive a first portion of a synchronization signal block (SSB) index in accordance with the demodulation reference signal; and
receive a second portion of the SSB index in accordance with the broadcast message.

4. The UE of claim 1, wherein the one or more processors are individually or collectively further configured to cause the UE to:
transmit a capability message indicating UE support for using a demodulation reference signal associated with the first cellular technology to receive the broadcast message, wherein receiving the broadcast message is in accordance with the capability message.

5. The UE of claim 1, wherein a location of the first subset of broadcast channel resources, the second subset of broadcast channel resources, or both, is within a carrier bandwidth associated with the UE.

6. The UE of claim 5, wherein a relative position in a frequency domain for the first subset of broadcast channel resources and the second subset of broadcast channel resources is defined with respect to the location.

7. The UE of claim 1, wherein the one or more processors are individually or collectively further configured to cause the UE to:
perform one or more blind decoding attempts of the broadcast message using a set of relative position hypotheses in a frequency domain for the first subset of broadcast channel resources and the second subset of broadcast channel resources.

8. The UE of claim 7, wherein a synchronization signal block (SSB) index associated with the first subset of broadcast channel resources and the second subset of broadcast channel resources is identified based on a successful blind decoding attempt.

9. The UE of claim 1, wherein the one or more processors are individually or collectively further configured to cause the UE to:
receive information identifying a relative position hypothesis in a frequency domain for the first subset of broadcast channel resources and the second subset of broadcast channel resources; and
decode the broadcast message in accordance with the relative position hypothesis.

10. The UE of claim 9, wherein the information comprises a first mapping between an identifier associated with the synchronization message and the relative position hypothesis, a second mapping between a synchronization raster associated with the set of synchronization channel resources and the relative position hypothesis, a third mapping between a frequency band associated with the set of synchronization channel resources and the relative position hypothesis, or a combination thereof.

11. A network entity, comprising:
one or more memories storing processor-executable code; and
one or more processors coupled with the one or more memories, wherein the one or more processors are individually or collectively configured to cause the network entity to:
output, via a set of synchronization channel resources, a synchronization message to a user equipment (UE), wherein the set of synchronization channel resources and a first subset of broadcast channel resources are both associated with a first cellular technology;
output, via a second subset of broadcast channel resources and according to the synchronization message, a broadcast message from the network entity, the second subset of broadcast channel resources associated with a second cellular technology that is different from the first cellular technology; and
communicate with the UE using the first cellular technology, the second cellular technology, or both, in accordance with the synchronization message and the broadcast message.

12. The network entity of claim 11, wherein the one or more processors are individually or collectively further configured to cause the network entity to:
output, via the first subset of broadcast channel resources, a demodulation reference signal associated with the first cellular technology, wherein outputting the broadcast message using the second cellular technology is in accordance with the demodulation reference signal.

13. The network entity of claim 12, wherein a first portion of a synchronization signal block (SSB) index is identified in accordance with the demodulation reference signal and a second portion of the SSB index is identified in accordance with the broadcast message.

14. The network entity of claim 11, wherein the one or more processors are individually or collectively further configured to cause the network entity to:
obtain a capability message indicating UE support for using a demodulation reference signal associated with the first cellular technology to receive the broadcast message, wherein outputting the broadcast message is in accordance with the capability message.

15. The network entity of claim 11, wherein a location of the first subset of broadcast channel resources, the second subset of broadcast channel resources, or both, is within a carrier bandwidth associated with the UE.

16. The network entity of claim 15, wherein a relative position in a frequency domain for the first subset of broadcast channel resources and the second subset of broadcast channel resources is defined with respect to the location.

17. The network entity of claim 11, wherein the one or more processors are individually or collectively further configured to cause the network entity to:
output information to the UE identifying a relative position hypothesis in a frequency domain for the first subset of broadcast channel resources and the second subset of broadcast channel resources, wherein the UE decodes the broadcast message in accordance with the relative position hypothesis.

18. The network entity of claim 17, wherein the information comprises a first mapping between an identifier associated with the synchronization message and the relative position hypothesis, a second mapping between a synchronization raster associated with the set of synchronization channel resources and the relative position hypothesis, a third mapping between a frequency band associated with the set of synchronization channel resources and the relative position hypothesis, or a combination thereof.

19. A method for wireless communications at a user equipment (UE), comprising:
receiving, via a set of synchronization channel resources, a synchronization message from a network entity, wherein the set of synchronization channel resources and a first subset of broadcast channel resources are both associated with a first cellular technology;
receiving, via a second subset of broadcast channel resources and according to the synchronization message, a broadcast message from the network entity, the second subset of broadcast channel resources associated with a second cellular technology that is different from the first cellular technology; and
communicating with the network entity using the first cellular technology, the second cellular technology, or both, in accordance with the synchronization message and the broadcast message.

20. A method for wireless communications at a network entity, comprising:
outputting, via a set of synchronization channel resources, a synchronization message to a user equipment (UE), wherein the set of synchronization channel resources and a first subset of broadcast channel resources are both associated with a first cellular technology;
outputting, via a second subset of broadcast channel resources and according to the synchronization message, a broadcast message from the network entity, the second subset of broadcast channel resources associated with a second cellular technology that is different from the first cellular technology; and
communicating with the UE using the first cellular technology, the second cellular technology, or both, in accordance with the synchronization message and the broadcast message.
